(19) United States
(12) Patent Application Publication
(10) Pub. No.: US 2008/0097031 A1
(43) Pub. Date: Apr. 24, 2008

(54) Thermoplastic Elastomer Composition

(76) Inventor: Kentaro Takesada, Osaka (JP)

Correspondence Address: BIRCH STEWART KOLASCH & BIRCH, PO BOX 747, FALLS CHURCH, VA, 22040-0747, US

(21) Appl. No.: 11/658,025

(22) PCT Filed: Jul. 19, 2005
(86) PCT No.: PCT/JP05/13239

§ 371 Date: Jan. 22, 2007

(30) Foreign Application Priority Data
Aug. 4, 2004 (JP) 2004-227996
Mar. 29, 2005 (JP) 2005-094919

(51) Int. Cl. C08L 33/08

(52) U.S. Cl. 525/94

(57) ABSTRACT

The present invention provides a thermoplastic elastomer composition having excellent injection moldability and producing molded products having high flexibility, low-temperature characteristics, both heat resistance and oil resistance, and excellent fatigue strength. The thermoplastic elastomer composition contains (A) an acrylic block copolymer and (B) an olefin thermoplastic elastomer, or further contains (C) a compatibilizer in addition to the components (A) and (B).

### TECHNICAL FIELD

The present invention relates to thermoplastic elastomer compositions having excellent injection moldability and producing molded products with high flexibility, low-temperature characteristics, both heat resistance and oil resistance, and excellent fatigue strength.

### BACKGROUND ART

Applications of thermoplastic elastomers have been developed in a wide range of fields, such as automobile parts, mechanical parts, and the like, by making the use of the characteristics that they need not be vulcanized and can be processed by a usual molding machine for thermoplastic resins, as compared with vulcanized rubber. Olefin thermoplastic elastomers are being used in increasing amounts from the viewpoint of light weight, anti-environmental pollution, and economics. In particular, olefin thermoplastic elastomers each formed by dynamic crosslinking between an olefin resin (sea phase) and EPDM rubber (island phase) are very excellent in heat resistance and low-temperature characteristics (Patent Document 1).

However, the olefin thermoplastic elastomers formed by dynamic crosslinking of EPDM rubber are short of oil resistance due to EPDM rubber, and molded products with a complicated shape, for example, a shape having bellows, such as an automobile constant-velocity joint boot, which are produced by injection-molding such elastomers, cause an increase in size of the bellow portion after removal from a mold due to the crystalline olefin resin used as a sea phase, as compared with vulcanized rubber. In other words, there is a problem with dimensions before and after removal from a mold.

There are also known olefin thermoplastic elastomers each produced by melt-kneading a graft copolymer composed of an olefin polymer and a vinyl polymer and acrylic rubber with a crosslinking agent or a co-crosslinking agent (for example, Patent Documents 2 and 3). However, these olefin thermoplastic elastomers are excellent in oil resistance, but are insufficient in low-temperature characteristics.

There are further known compatible blends each containing a nonpolar thermoplastic elastomer, a polar thermoplastic elastomer, and a compatibilizer (Patent Document 4). However, an acrylic thermoplastic elastomer is not described in this document.

Patent Document 1: Japanese Unexamined Patent Application Publication No. 6-306217

Patent Document 2: Japanese Unexamined Patent Application Publication No. 2003-277571

Patent Document 3: Japanese Unexamined Patent Application Publication No. 2004-2651

Patent Document 4: PCT Japanese Translation Patent Publication No. 2001-525477

### DISCLOSURE OF INVENTION

### Problem to be Solved by the Invention

The present invention aims at providing thermoplastic elastomer compositions having excellent dimensional properties in injection molding and producing molded products having high flexibility and excellent heat resistance, oil resistance, and fatigue strength.

### Means for Solving the Problem

As a result of intensive research for solving the above-mentioned problem, the inventors of the present invention have achieved the invention by combining a low-cost olefin thermoplastic elastomer having high heat resistance and an acrylic block copolymer.

Namely, the present invention relates to a thermoplastic elastomer composition containing (A) an acrylic block copolymer and (B) an olefin thermoplastic elastomer.

In a preferred embodiment, the thermoplastic elastomer composition contains (C) a compatibilizer in addition to the components (A) and (B).

In a further preferred embodiment, the thermoplastic elastomer composition contains 50 to 600 parts by weight of the olefin thermoplastic elastomer (B) and 5 to 50 parts by weight of the compatibilizer (C) relative to 100 parts by weight of the acrylic block copolymer (A).

In a further preferred embodiment, the thermoplastic elastomer composition contains (D) a polypropylene homopolymer in addition to the components (A), (B), and (C).

The acrylic block copolymer (A) preferably includes an acrylic polymer block (a) and a methacrylic polymer block (b), at least one of the polymer blocks having a reactive functional group (c).

The reactive functional group (c) in the acrylic block copolymer (A) preferably has an acid anhydride group-containing unit (c1) and/or a carboxyl group-containing unit (c2) which are represented by formula (1): 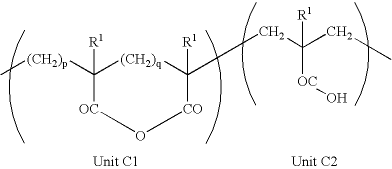
(wherein R¹s are each a hydrogen atom or a methyl group and may be the same or different, p is an integer of 0 or 1, and q is an integer of 0 to 3).

Furthermore, the acrylic block copolymer (A) preferably contains 0.1 to 50% by weight of the carboxyl group-containing unit (c2).

The acrylic block copolymer (A) preferably contains 50 to 90% by weight of the acrylic polymer block (a) and 50 to 10% by weight of the methacrylic polymer block (b).

The acrylic block copolymer (A) is preferably a block copolymer produced by atom transfer radical polymerization.

The olefin thermoplastic elastomer (B) is preferably produced by dynamic crosslinking of EPDM rubber or acrylonitrile-butadiene rubber in an olefin resin.

The compatibilizer (C) is preferably an olefin thermoplastic resin containing an epoxy group.

The present invention also relates to a molded product for automobiles, domestic electric alliances, or office electric alliances, which is produced by injection-molding the thermoplastic elastomer composition.

In a preferred embodiment, the present invention relates to an automobile seal produced by injection-molding the thermoplastic elastomer composition.

In a preferred embodiment, the present invention relates to a constant-velocity joint boot produced by injection-molding the thermoplastic elastomer composition.

In a preferred embodiment, the present invention relates to an accelerator pedal produced by injection-molding the thermoplastic elastomer composition.

### ADVANTAGE OF THE INVENTION

The present invention can provide a thermoplastic elastomer composition having high flexibility, excellent heat resistance and oil resistance, high dimensional properties in injection molding, and excellent fatigue strength. Therefore, the thermoplastic elastomer composition of the present invention is suitable for molded products for automobiles, domestic electric appliances, or office electric appliances, particularly seals for automobiles, e.g., an automobile constant-velocity joint boot and accelerator pedal.

### BEST MODE FOR CARRYING OUT THE INVENTION

<(A) Acrylic Block Copolymer>

An acrylic block copolymer (A) includes an acrylic polymer block (a) and a methacrylic polymer block (b). The structure of the acrylic block copolymer (A) may be either a linear block copolymer or a branched (star) block copolymer, or a mixture thereof. The structure of the acrylic block copolymer (A) may be any one of these copolymers according to processing properties and mechanical properties, but the linear block copolymer is preferred from the viewpoint of cost and ease of polymerization.

The linear block copolymer may have any linear block structure. However, in view of the physical properties of the block copolymer or the physical properties of the resultant composition, the acrylic block copolymer (A) including the acrylic polymer block (a) (referred to as the “polymer block (a)” or “block (a)” hereinafter) and the methacrylic polymer block (b) (referred to as the “polymer block (b)” or “block (b)” hereinafter) is preferably at least one selected from the group consisting of block copolymers represented by the formulae (a-b)ₙ, b-(a-b)ₙ, and (a-b)ₙ-a (wherein n is an integer of 1 to 3). Among these copolymers, an (a-b) diblock copolymer or (b-a-b) triblock copolymer, or a mixture thereof is preferred from the viewpoint of ease of handling in processing and the physical properties of the resultant composition.

The acrylic block copolymer (A) preferably has a reactive functional group (c) in at least one of the blocks (a) and (b).

The reactive functional group (c) preferably has at least one unit (c) including an acid anhydride group-containing unit (c1) and/or a carboxyl group-containing unit (c2) which are represented by formula (1): 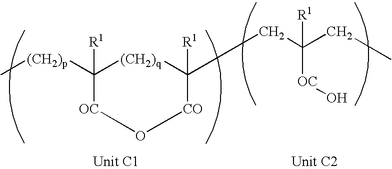
(wherein R¹s are each a hydrogen atom or a methyl group and may be the same or different, p is an integer of 0 or 1, and q is an integer of 0 to 3) per polymer block of at least either the acrylic polymer block (a) or the methacrylic polymer block (b). When the number of the units (c) is two or more, the units may be polymerized by random copolymerization or block copolymerization.

For example, in a (b-a-b) triblock copolymer, the block copolymer may contain the unit (c) in any one of the forms of (b/c)-a-b, (b/c)-a-(b/c), c-b-a-b, c-b-a-b-c, b-(a/c)-b, b-a-c-b, and b-c-a-b. Herein, (a/c) represents that the block (a) contains the unit (c), (b/c) represents that the block (b) contains the unit (c), c-a- and a-c- each represent that the unit (c) is bonded to an end of the block (a). All the expressions (a/c), (b/c), c-a-, and a-c-belong to the block (a) or (b).

The number-average molecular weight of the acrylic block copolymer (A) is preferably 30,000 to 500,000, more preferably 40,000 to 400,000, and most preferably 50,000 to 300,000. When the molecular weigh is less than 30,000, sufficient mechanical properties as an elastomer may be not exhibited, while when the molecular weight exceeds 500,000, processing properties may degrade.

The ratio (Mw/Mn) of the weight-average molecular weight (Mw) to the number-average molecular weight (Mn) of the acrylic block copolymer (A) is preferably 1 to 2, and more preferably 1 to 1.8. With the Mw/Mn ratio of over 2, the compression set of the acrylic block copolymer (A) may degrade. In the present invention, the number-average molecular weight (Mn) and the weight-average molecular weight (Mw) are determined in terms of polystyrene by gel permeation chromatography using chloroform as a mobile phase.

The ratio between the acrylic polymer block (a) and the methacrylic polymer block (b) constituting the acrylic block copolymer (A) may be determined by the required physical properties, the moldability required for processing the composition, and the required molecular weights of the acrylic polymer block (a) and the methacrylic polymer block (b). As an example of the ratio between the acrylic polymer block (a) and the methacrylic polymer block (b), the content of the acrylic polymer block (a) preferably ranges from 50% to 90% by weight, more preferably from 50% to 80% by weight, and particularly preferably from 50% to 70% by weight, and the content of the methacrylic polymer block (b) preferably ranges from 50% to 10% by weight, more preferably from 50% to 20% by weight, and particularly preferably from 50% to 30% by weight. When the content of the acrylic polymer block (a) is less than 50% by weight, the mechanical properties as an elastomer, particularly, elongation at break, may decrease, and flexibility may decrease. When the content of the block (a) exceeds 90% by weight, rubber elasticity at a high temperature may decrease.

The glass transition temperatures of the acrylic polymer block (a) and the methacrylic polymer block (b) which constitute the acrylic block copolymer (A) preferably satisfy the following equation:
Tgₐ<Tg_{b}
wherein Tgₐ is the glass transition temperature of the acrylic polymer block (a), and Tg_{b} is the glass transition temperature of the methacrylic polymer block (b).

The glass transition temperatures (Tg) of the acrylic polymer block (a) and the methacrylic polymer block (b) can be roughly determined using the weight ratio of a monomer in each polymer block according to the following Fox equation:
1/Tg=(W₁/Tg₁)+(W₂/Tg₂)+ . . . +(Wₘ/Tgₘ) W₁+W₂+ . . . +Wₘ=1
(wherein Tg represents the glass transition temperature of the polymer block, Tg₁, Tg₂, . . . , Tgₘ each represent the glass transition temperature of a polymer (homopolymer) of each monomer, and W₁, W₂, . . . , Wₘ each represent the weight ratio of each monomer.

In the Fox equation, the value described in, for example, Polymer Handbook Third Edition, Wiley-Interscience, 1989 is used as the glass transition temperature of a polymer of each monomer.

Examples of the acrylic block copolymer (A) include the acrylic block copolymers produced in Production Examples 1-2, 2-2, and 3-2 below. The acrylic block copolymer will be described in further detail below.

<Acrylic Polymer Block (a)>

The acrylic polymer block (a) of the acrylic block copolymer (A) preferably has a glass transition temperature satisfying a relation, preferably Tgₐ<Tg_{b}, to that of the methacrylic polymer block (b). The acrylic polymer block (a) preferably contains 50 to 100% by weight and preferably 60 to 100% by weight of a unit containing an acrylate, 0 to 50% by weight and preferably 0 to 40% by weight of a functional group-containing monomer serving as a precursor of the unit (c), and 0 to 50% by weight and preferably 0 to 25% by weight of another vinyl monomer copolymerizable with these components on the basis of the total weight of the block (a). When the content of the unit containing an acrylate is less than 50% by weight, a physical property characteristic of use of an acrylate, particularly tensile elongation, may decrease.

The molecular weight of the acrylic polymer block (a) may be determined by the required elastic modulus and rubber elasticity of the acrylic polymer block (a) and the time required for polymerization thereof.

For example, a range of the required number-average molecular weight M_{A} of the acrylic polymer block (a) is preferably M_{A}>3,000, more preferably M_{A}>5,000, further preferably M_{A}>10,000, particularly preferably M_{A}>20,000, and most preferably M_{A}>40,000. When the number-average molecular weight M_{A} of the acrylic polymer block (a) is less than the above range, the tensile elongation decreases. However, with the higher number-average molecular weight, the polymerization time tends to increase, and thus the molecular weight may be determined according to the required productivity. However, the molecular weight is preferably 500,000 or less and more preferably 300,000 or less.

Examples of the acrylate constituting the acrylic polymer block (a) include aliphatic hydrocarbon (e.g., alkyl having 1 to 18 carbon atoms) acrylates, such as methyl acrylate, ethyl acrylate, n-propyl acrylate, n-butyl acrylate, isobutyl acrylate, n-pentyl acrylate, n-hexyl acrylate, n-heptyl acrylate, n-octyl acrylate, 2-ethylhexyl acrylate, nonyl acrylate, decyl acrylate, dodecyl acrylate, and stearyl acrylate; alicyclic hydrocarbon acrylates, such as cyclohexyl acrylate and isobornyl acrylate; aromatic hydrocarbon acrylates, such as phenyl acrylate and tolyl acrylate; aralkyl acrylates, such as benzyl acrylate; esters of acrylic acid with functional group-containing alcohols having ether oxygen, such as 2-methoxyethyl acrylate and 3-methoxybutyl acrylate; and fluoroalkyl acrylates, such as trifluoromethylmethyl acrylate, 2-trifluoromethylethyl acrylate, 2-perfluoroethylethyl acrylate, 2-perfluoroethyl-2-perfluorobutylethyl acrylate, 2-perfluoroethyl acrylate, perfluoromethyl acrylate, diperfluoromethylmethyl acrylate, 2-perfluoromethyl-2-perfluoroethylmethyl acrylate, 2-perfluorohexylethyl acrylate, 2-perfluorodecylethyl acrylate, and 2-perfluorohexadecylethyl acrylate. These compounds may be used alone or in combination or two or more. Among these acrylates, n-butyl acrylate is preferred from the viewpoint of low-temperature characteristics, compression set, cost, and availability. When oil resistance and mechanical properties are required, ethyl acrylate is preferred. When low-temperature characteristics, mechanical properties, and compression set are required, 2-ethylhexyl acrylate is preferred. In view of mechanical properties, oil resistance, and low-temperature characteristics, a mixture containing 10 to 90% by weight of 2-methoxyethyl acrylate, 10 to 90% by weight of n-butyl acrylate, and 0 to 80% by weight of ethyl acrylate based on the whole of the acrylic polymer block (a) is preferred, and a mixture containing 15 to 85% by weight of 2-methoxyethyl acrylate, 15 to 85% by weight of n-butyl acrylate, and 0 to 70% by weight of ethyl acrylate is more preferred.

Examples of the functional group serving as a precursor of the unit (c) include, but are not limited to, t-butyl acrylate, isopropyl acrylate, α,α-dimethylbenzyl acrylate, α-methylbenzyl acrylate, tert-butyl methacrylate, isopropyl methacrylate, α,α-dimethylbenzyl methacrylate, and α-methylbenzyl methacrylate. A method for introducing the unit (c) in the acrylic block copolymer (A) will be described below.

Examples of the vinyl monomer copolymerizable with the acrylate constituting the acrylic polymer block (a) include methacrylates, aromatic alkenyl compounds, vinyl cyanide compounds, conjugated diene compounds, halogen-containing unsaturated compounds, unsaturated dicarboxylic acid compounds, vinyl ester compounds, and maleimide compounds.

Examples of the methacrylates include aliphatic hydrocarbon (e.g., alkyl having 1 to 18 carbon atoms) methacrylates, such as methyl methacrylate, ethyl methacrylate, n-propyl methacrylate, n-butyl methacrylate, isobutyl methacrylate, n-pentyl methacrylate, n-hexyl methacrylate, n-heptyl methacrylate, n-octyl methacrylate, 2-ethylhexyl methacrylate, nonyl methacrylate, decyl methacrylate, dodecyl methacrylate, and stearyl methacrylate; alicyclic hydrocarbon methacrylates, such as cyclohexyl methacrylate and isobornyl methacrylate; aralkyl methacrylates, such as benzyl methacrylate; aromatic hydrocarbon methacrylates, such as phenyl methacrylate and tolyl methacrylate; esters of methacrylic acid with functional group-containing alcohols having ether oxygen, such as 2-methoxyethyl methacrylate and 3-methoxybutyl methacrylate; and fluoroalkyl methacrylates, such as trifluoromethylmethyl methacrylate, 2-trifluoromethylethyl methacrylate, 2-perfluoroethylethyl methacrylate, 2-perfluoroethyl-2-perfluorobutylethyl methacrylate, 2-perfluoroethyl methacrylate, perfluoromethyl methacrylate, diperfluoromethylmethyl methacrylate, 2-perfluoromethyl-2-perfluoroethylmethyl methacrylate, 2-perfluorohexylethyl methacrylate, 2-perfluorodecylethyl methacrylate, and 2-perfluorohexadecylethyl methacrylate.

Examples of the aromatic alkenyl compounds include styrene, α-methylstyrene, p-methylstyrene, and p-methoxystyrene.

Examples of the vinyl cyanide compounds include acrylonitrile and methacrylonitrile.

Examples of the conjugated diene compounds include butadiene and isoprene.

Examples of the halogen-containing unsaturated compounds include vinyl chloride, vinylidene chloride, perfluoroethylene, perfluoropropylene, and vinylidene fluoride.

Examples of the unsaturated dicarboxylic acid compounds include maleic anhydride, maleic acid, maleic acid monoalkyl and dialkyl esters, fumaric acid, and fumaric acid monoalkyl and dialkyl esters.

Examples of the vinyl ester compounds include vinyl acetate, vinyl propionate, vinyl pivalate, vinyl benzoate, and vinyl cinnamate.

Examples of the maleimide compounds include maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

These copolymerizable vinyl monomers may be used alone or in combination of two or more. A preferred one can be selected from the above-listed vinyl monomers according to the required glass transition temperature, elastic modulus, and polarity of the acrylic polymer block (a), and the required physical properties and compatibility with the olefin thermoplastic elastomer (B) when the acrylic block copolymer (A) is used as a composition. For example, acrylonitrile may be copolymerized for improving oil resistance.

The glass transition temperature of the acrylic polymer block (a) is preferably 50° C. or less and more preferably 0° C. or less. With the glass transition temperature higher than 50° C., the rubber elasticity of the acrylic block copolymer (A) may decrease.

The glass transition temperature (Tgₐ) of the acrylic polymer block (a) can be set by controlling the weight ratio of each constituent monomer of the polymer block on the basis of the polymerization ratio of each monomer using the glass transition temperature of a homopolymer of each constituent monomer of the polymer block according to the Fox equation, the glass transition temperature of a homopolymer being given in the Polymer Handbook, 3rd Edition.

Examples of the acrylic polymer block (a) include the acrylic polymer blocks contained in the acrylic block copolymers produced in Production Examples 1-2, 2-2, and 3-2 described below.

<Methacrylic Polymer Block (b)>

The methacrylic polymer block (b) of the acrylic block copolymer (A) preferably has a glass transition temperature satisfying a relation, preferably Tgₐ<Tg_{b}, to the acrylic polymer block (a). From the viewpoint of cost, availability, and ease of the production of the acrylic block copolymer (A) having desired physical properties, the methacrylic polymer block (b) preferably contains 50 to 100% by weight and preferably 50 to 85% by weight of a unit containing a methacrylate, 10 to 99.5% by weight and preferably 20 to 99.5% by weight of a functional group-containing monomer serving as a precursor of the unit (c), and 0.1 to 50% by weight and preferably 0.1 to 25% by weight of another vinyl monomer copolymerizable with these components on the basis of the total weight of the block (b).

The molecular weight of the methacrylic polymer block (b) may be determined according to the required cohesive force of the methacrylic polymer block (b) and the time required for polymerization thereof.

The cohesive force depends on molecular interaction (i.e., polarity) and the degree of entanglement. As the number-average molecular weight increases, the number of entanglement points increases to increase cohesive force.

Namely, when a cohesive force is required, a preferred range of the required number-average molecular weight M_{B} of the methacrylic polymer block (b) is, for example, M_{B}>MC_{B} wherein MC_{B} is the molecular weight of an entanglement strand constituting the methacrylic polymer block (b). Furthermore, for example, when a higher cohesive force is required, a preferred range is M_{B}>2×MC_{B}, and conversely, when both a certain degree of cohesive force and creep property are desired to be satisfied, a preferred range is MC_{B}<M_{B}<2×MC_{B}. With respect to the molecular weight of an entanglement strand, the document of Wu, et al. (Polym. Eng. and Sci.), 1990, vol. 30, PP. 753), etc. may be referred to. For example, when a cohesive force is required of the methacrylic polymer block (b) which is entirely composed of methyl methacrylate, a preferred range of the number-average molecular weight of the methacrylic polymer block (b) is, for example, 9,200 or more. However, when the unit (c) is contained in the methacrylic polymer block (b), the number-average molecular weight can be set to a lower value because the cohesive force due to the unit (c) is added. As the number-average molecular weight increases, the polymerization time tends to increase. Therefore, the number-average molecular weight may be determined according to required productivity, but is preferably 200,000 or less and more preferably 100,000 or less.

The methacrylate constituting the methacrylic polymer block (b) can be exemplified by the above-listed vinyl monomers copolymerizable with the acrylate constituting the acrylic polymer block (a). The methacrylates may be used alone or in combination of two or more. In particular, methyl methacrylate is preferred from the viewpoint of cost and easy availability.

The functional group-containing monomer serving as a precursor of the unit (c) is exemplified by the same as the constituent monomers described above for the acrylic polymer block (a).

Examples of the vinyl monomer copolymerizable with the methacrylate which constitutes the methacrylic polymer block (b) include acrylates, aromatic alkenyl compounds, vinyl cyanide compounds, conjugated diene compounds, halogen-containing unsaturated compounds, unsaturated dicarboxylic acid compounds, vinyl ester compounds, and maleimide compounds.

Examples of the acrylates include the same as the constituent monomers described above for the acrylic polymer block (a).

The aromatic alkenyl compounds, the vinyl cyanide compounds, the conjugated diene compounds, the halogen-containing unsaturated compounds, the unsaturated dicarboxylic acid compounds, the vinyl ester compounds, and the maleimide compounds can be exemplified by the same as the constituent monomers described above as the copolymerizable vinyl monomers for the acrylic polymer block (a).

As the copolymerizable vinyl monomer, at least one of the above-described constituent monomers is used. Although a methyl methacrylate polymer is substantially quantitatively depolymerized by thermal decomposition, the depolymerization of the methacrylic polymer block (b) composed of methyl methacrylate can be suppressed by copolymerization with an acrylate, e.g., methyl acrylate, ethyl acrylate, butyl acrylate, or 2-methoxyethyl acrylate, a mixture thereof, styrene, or the like. Furthermore, acrylonitrile can be copolymerized for improving oil resistance.

The glass transition temperature (Tg_{b}) of the methacrylic polymer block (b) is preferably 100° C. or more and more preferably 110° C. or more. When the glass transition temperature is less than 100° C., rubber elasticity at a high temperature may decrease to lower than a desired value.

The glass transition temperature (Tg_{b}) of the methacrylic polymer block (b) can be set by changing the weight ratio of each constituent monomer of the polymer block on the basis of the polymerization ratio of each monomer using the glass transition temperature of a homopolymer of each constituent monomer of the polymer block according to the Fox equation, the glass transition temperature of a homopolymer being given in the Polymer Handbook, 3rd Edition.

Examples of the methacrylic polymer block (b) include the methacrylic polymer blocks contained in the acrylic block copolymers produced in Production Examples 1-2, 2-2, and 3-2 described below.

<Unit (c; Reactive Functional Group)>

The unit (c) has reactivity to a compound containing an amino group, a hydroxyl group, an epoxy group, or the like, and is thus characterized by being usable as, for example, a crosslinking portion with a compatibilizer (C) when the acrylic block copolymer (A) is blended with a thermoplastic elastomer (B). Also, the unit (c) has a high glass transition temperature (Tg) and can thus improve the heat resistance of the acrylic block copolymer (A) when introduced in the methacrylic polymer block (b) serving as a hard segment. For example, the glass transition temperature of polymethacrylic anhydride which is a polymer containing the unit (c) is as high as 159° C., and the heat resistance of the acrylic block copolymer (A) can be desirably improved by introducing the unit (c).

The unit (c) includes an acid anhydride group-containing unit (c1) and a carboxyl group-containing unit (c2) represented by formula (1): 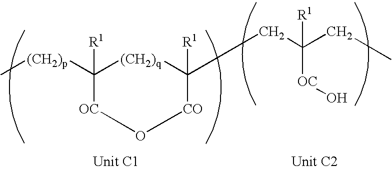
(wherein R¹s are each a hydrogen atom or a methyl group and may be the same or different, p is an integer of 0 or 1, and q is an integer of 0 to 3).

In formula (1), q is an integer of 0 to 3, preferably 0 or 1, and more preferably 1. When q exceeds 3, polymerization may become complicated, and cyclization with an acid anhydride group may become difficult.

In formula (1), p is an integer of 0 or 1. When q is 0, p is preferably also 0, and when q is 1 to 3, p is preferably 1. The unit (c) is contained in the acrylic polymer block (a) and/or the methacrylic polymer block (b).

The introduction site of the unit (c) can be appropriately selected according to the reaction points of the acrylic block copolymer (A), the cohesive forces and glass transition temperatures of the blocks which constitute the acrylic block copolymer (A), and the required physical properties of the acrylic block copolymer (A). From the viewpoint of the heat resistance and thermal decomposition resistance of the acrylic block copolymer (A), the unit (c) is preferably introduced into the methacrylic polymer block (b). From the viewpoint of imparting rubber elasticity to the acrylic block copolymer (A), the unit (c) is preferably introduced as a crosslinking reaction site (crosslinking point) into the acrylic polymer block (a). From the viewpoint of control of the reaction points, heat resistance, and rubber elasticity, the unit (c) is preferably contained in either the acrylic polymer block (a) or the methacrylic polymer block (b). When the unit (c) is contained in the methacrylic polymer block (b), all R¹s in formula (1) are preferably methyl groups, and when the unit (c) is contained in the acrylic polymer block (a), all R¹s in formula (1) are preferably hydrogen atoms. When R¹s in the unit (c) contained in the methacrylic polymer block (b) are hydrogen atoms or R¹s in the unit (c) contained in the acrylic polymer block (a) are methyl groups, a difference between the glass transition temperatures of the acrylic polymer block (a) and the methacrylic polymer block (b) tends to decrease, thereby decreasing the rubber elasticity of the acrylic block copolymer (A).

A preferred range of the content of the unit (c) varies with the cohesive force of the unit (c), reactivity of the unit (c) to the compatibilizer (C), the structure and composition of the acrylic block copolymer (A), the number and glass transition temperatures of the blocks constituting the acrylic block copolymer (A), the introduction sites and forms of the acid anhydride group-containing unit (c1) and the carboxyl group-containing unit (c2). However, the content of the unit (c) is preferably 0.1 to 99.9% by weight, more preferably 0.1 to 80% by weight, and most preferably 0.1 to 50% by weight relative to the total weight of the acrylic block copolymer (A). When the content of the unit (c) is less than 0.1% by weight, compatibility between the acrylic block copolymer (A) and the compatibilizer (C) may become insufficient. When less than 0.1% by weight of the unit (c) having high Tg is introduced into the methacrylic polymer block (b) serving as a hard segment, for improving the heat resistance of the methacrylic polymer block (b), the heat resistance may be not sufficiently improved, and expression of rubber elasticity at high temperatures may be decreased. On the other hand, when the content exceeds 99.9% by weight, the cohesive force may be excessively increased, thereby decreasing productivity.

When the acrylic block copolymer (A) contains the carboxyl group-containing unit (c2), the heat resistance and cohesive force are further improved. The carboxyl group-containing unit (c2) has strong cohesive force, and a polymer of a carboxyl group-containing monomer has a high glass transition temperature (Tg). For example, polymethacrylic acid has a glass transition temperature (Tg) of as high as 228° C., and thus improves the heat resistance of a block copolymer. Although a functional group such as a hydroxyl group also has a hydrogen bonding ability, a hydroxyl group-containing monomer has lower Tg and a lower effect of improving heat resistance than the carboxyl group-containing monomer. Therefore, the heat resistance and cohesive force of the acrylic block copolymer (A) can be preferably improved by introducing the carboxyl group-containing unit (c2).

The content of the carboxyl group-containing unit (c2) may be a number of at least one per polymer block. When the number is 2 or more, the unit (c2) may be polymerized by random copolymerization or block copolymerization.

A preferred range of the content of the carboxyl group-containing unit (c2) varies with the cohesive force of the carboxyl group-containing unit (c2), the structure, the composition, and the number of constituent blocks of the block copolymer, and the introduction site and form of the carboxyl group-containing unit (c2).

The content of the carboxyl group-containing unit (c2) is preferably 0.1 to 50% by weight, more preferably 0.5 to 50% by weight, and most preferably 1 to 40% by weight relative to the total of the acrylic block copolymer (A).

When the content exceeds 50% by weight, the carboxyl group-containing unit (c2) tends to be cyclized with the adjacent ester unit at a high temperature, and thus the physical properties after molding may be changed to cause difficulty in forming products having stable physical properties. When the carboxyl group-containing unit (c2) is produced in the step of introducing the unit (c), the unit (c2) is generally produced in an amount of 0.1% by weight or more. If the amount is less than 0.1% by weight, the heat resistance and cohesive force may be not sufficiently improved even by introducing the carboxyl group-containing unit (c2) into the methacrylic polymer block (b) serving as a hard segment.

<Process for Producing Acrylic Block Copolymer (A)>

The process for producing the acrylic block copolymer (A) is not particularly limited, but controlled polymerization is preferably used. Examples of the controlled polymerization include living anionic polymerization, radical polymerization using a chain transfer agent, and recently developed living radical polymerization. The living radical polymerization is preferred from the viewpoint of the molecular weight and structure control of the block copolymer and the ability of copolymerization with a monomer having a crosslinkable functional group.

In a narrow sense, the term “living polymerization” means polymerization in which activity is maintained at ends. However, the living polymerization generally includes pseudo-living polymerization in which inactivated and activated termini are in equilibrium. In the present invention, the living radical polymerization means radical polymerization in which activated and inactivated polymerization termini are maintained in equilibrium. In recent years, this radical polymerization has been positively studied by various groups.

Examples of the living radical polymerization include radical polymerization using a chain transfer agent such as polysulfide, radical polymerization using a cobalt porphyrin complex (Journal of American Chemical Society, 1994, 116, 7943) or a nitroxide compound (Macromolecules, 1994, 27, 7228) as a radical scavenger, and atom transfer radical polymerization (ATRP) using an organic halide as an initiator and a transition metal complex as a catalyst. In the present invention, any one of these the polymerization processes may be used, but the atom transfer radical polymerization is preferred in view of ease of control.

The atom transfer radical polymerization is performed using an organic halide or a halogenated sulfonyl compound as an initiator and a metal complex as a catalyst, the metal complex having a VIII, IX, X, or XI group element in the periodic table as a central metal (for example, Matyjaszewski et al., Journal of American Chemical Society, 1995, 117, 5614, Macromolecules, 1995, 28, 7901, Science, 1996, 272, 866, or Sawamoto et al., Macromolecules, 1995, 28, 1721).

The above-described polymerization processes belong to radical polymerization which generally has a high polymerization rate and easily causes termination reaction by radical coupling. However, in these polymerization processes, polymerization proceeds in a living manner to produce a polymer having a narrow molecular weight distribution, i.e., a Mw/Mn ratio of about 1.1 to 1.5, and the molecular weight can be freely controlled by the charge ratio of the monomer to the initiator.

In the atom transfer radical polymerization process, a monofunctional, difunctional, or polyfunctional compound can be used as the organic halide or halogenated sulfonyl compound serving as the initiator. These compounds can be properly used according to purposes. When a diblock copolymer is produced, a monofunctional compound is preferred. When an a-b-a triblock copolymer or b-a-b triblock copolymer is produced, a difunctional compound is preferably used. When a branched block copolymer is produced, a polyfunctional compound is preferably used.

Examples of the monofunctional compound include compounds represented by the following chemical formulae:
C₆H₅—CH₂X
C₆H₅—CHX—CH₃
C₆H₅—C(CH₃)₂X
R¹—CHX—COOR²
R¹—C(CH₃) X—COOR²
R¹—CHX—CO—R²
R¹—C(CH₃) X—CO—R²
R¹—C₆H₄—SO₂X
   (wherein C₆H₄ represents phenylene which may be ortho-, meta- or para-substituted, R¹ represents a hydrogen atom, alkyl having 1 to 20 carbon atoms, aryl having 6 to 20 carbon atoms, or aralkyl having 7 to 20 carbon atoms, X represents chlorine, bromine, or iodine, and R² represents a monovalent organic group having 1 to 20 carbon atoms).

Examples of the difunctional compound include compounds represent by the following chemical formulae:
X—CH₂—C₆H₄—CH₂—X
X—CH(CH₃)—C₆H₄—CH(CH₃)—X
X—C(CH₃)₂—C₆H₄—C(CH₃)₂—X
X—CH(COOR³)—(CH₂)ₙ—CH(COOR³)—X
X—C(CH₃)(COOR³)—(CH₂)ₙ—C(CH₃)(COOR³)—X
X—CH(COR³)—(CH₂)ₙ—CH(COR³)—X
X—C(CH₃)(COR³)—(CH₂)ₙ—C(CH₃)(COR³)—X
X—CH₂—CO—CH₂—X
X—CH(CH₃)—CO—CH(CH₃)—X
X—C(CH₃)₂—CO—C(CH₃)₂X
X—CH(C₆H₅)—CO—CH(C₆H₅)—X
X—CH₂—COO—(CH₂)ₙ—OCO—CH₂—X
X—CH(CH₃)—COO—(CH₂)ₙ—OCO—CH(CH₃)—X
X—C(CH₃)₂—COO— (CH₂)ₙ—OCO—C(CH₃)₂—X
X—CH₂—CO—CO—CH₂—X
X—CH(CH₃)—CO—CO—CH(CH₃)—X
X—C(CH₃)₂—CO—CO—C(CH₃)₂—X
X—CH₂—COO—C₆H₄—OCO—CH₂—X
X—CH(CH₃)—COO—C₆H₄—OCO—CH(CH₃)—X
X—C(CH₃)₂—COO—C₆H₄—OCO—C(CH₃)₂—X
X—SO₂—C₆H₄—SO₂—X
   (wherein R³ represents alkyl having 1 to 20 carbon atoms, aryl having 6 to 20 carbon atoms, or aralkyl having 7 to 20 carbon atoms, C₆H₄ represents phenylene which may be ortho-, meta-, or para-substituted, C₆H₅ represents phenyl, n represents an integer of 0 to 20, and X represents chlorine, bromine, or iodine).

Examples of the polyfunctional compound include compounds represent by the following chemical formulae:
C₆H₃ (CH₂X)₃
C₆H₃ (CH(CH₃)—X)₃
C₆H₃ (C(CH₃)₂—X)₃
C₆H₃ (OCO—CH₂X)₃
C₆H₃ (OCO—CH(CH₃)—X)₃
C₆H₃ (OCO—C(CH₃)₂—X)₃
C₆H₃ (SO₂X)₃
   (wherein C₆H₃ represents trisubstituted phenyl which may be substituted at any of the 1- to 6-positions, and X represents chlorine, bromine, or iodine).

In the organic halide or halogenated sulfonyl compound used as the initiator, the carbon to which a halogen is bonded is bonded to a carbonyl group or phenyl group, and thus a carbon-halogen bond is activated to initiate polymerization. The amount of the initiator used may be determined by the ratio to the monomer used according to the required molecular weight of the block copolymer. Namely, the molecular weight of the block copolymer can be controlled by controlling the number of the monomer molecules used per molecule of the initiator.

The transition metal complex used as the catalyst of the atom transfer radical polymerization is not particularly limited, but a complex of monovalent or zerovalent copper, divalent ruthenium, divalent iron, or divalent nickel is preferred. In particular, a copper complex is particularly preferred from the viewpoint of cost and reaction control.

Examples of a monovalent copper compound include cuprous chloride, cuprous bromide, cuprous iodide, cuprous cyanide, cuprous oxide, and cuprous perchlorate. When a copper compound is used, 2,2′-bipyridyl or its derivative, 1,10-phenanthroline or its derivative, or a polyamine such as tetramethylethylenediamine (TMEDA), pentamethyldiethylenetriamine, or hexamethyl(2-aminoethyl)amine can be added as a ligand, for increasing catalytic activity. Also, a tristriphenylphosphine complex (RuCl₂(PPh₃)₃) of divalent ruthenium chloride can be used as the catalyst.

When a ruthenium compound is used as the catalyst, an aluminum alkoxide can be added as an activator. Furthermore, a bistriphenylphosphine complex (FeCl₂(PPh₃)₂) of divalent iron, a bistriphenylphosphine complex (NiCl₂(PPh₃)₂) Of divalent nickel, or a bistributylphosphine complex (NiBr₂(PBu₃)₂) of divalent nickel can be used as the catalyst. The amounts of the catalyst, ligand, and activator used are not particularly limited, but can be properly determined on the basis of a relation between the amounts of the initiator, monomer, and solvent used and the required reaction rate.

The atom transfer radical polymerization can be performed in the absence (bulk polymerization) or presence of a solvent. Examples of the solvent include hydrocarbon solvents, such as benzene and toluene; halogenated hydrocarbon solvents, such as methylene chloride and chloroform; ketone solvents, such as acetone, methyl ethyl ketone, and methyl isobutyl ketone; alcohol solvents, such as methanol, ethanol, propanol, isopropanol, n-butanol, and tert-butanol; nitrile solvents, such as acetonitrile, propionitrile, and benzonitrile; ester solvents, such as ethyl acetate and butyl acetate; and carbonate solvents, such as ethylene carbonate and propylene carbonate. At least one of these solvents can be mixed. The amount of the solvent used can be properly determined on the basis of a relation between the viscosity of the whole system and the reaction rate (i.e., stirring efficiency).

The atom transfer radical polymerization can be performed preferably at room temperature to 200° C. and more preferably at 50° C. to 150° C. At the atom transfer radical polymerization temperature lower than room temperature, the viscosity may be excessively increased to decrease the reaction rate. At the polymerization temperature over 200° C., an inexpensive polymerization solvent cannot be used in some cases.

Examples of the process for producing a block copolymer by the atom transfer radical polymerization include a process of sequentially adding monomers, a process of synthesizing a polymer and then polymerizing a monomer of another polymer block using the synthesized polymer as a polymer initiator, and a process of bonding separately produced polymers by reaction. These processes can be properly used according to purposes. However, the process of sequentially adding monomers is preferred from the viewpoint of simplicity of the production process.

The unit (c) containing the acid anhydride group-containing unit (c1) and/or the carboxyl group-containing unit (c2) is introduced in the acrylic block copolymer (A) by the following process:

The process for introducing the acid anhydride group-containing unit (c1) is not particularly limited, but a unit containing a group serving as a precursor of an acid anhydride group is preferably introduced in a block copolymer, followed by cyclization. This process will be described in detail below.

A block copolymer having at least one unit represented by formula (2): 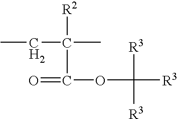
(wherein R² represents a hydrogen atom or methyl, and R³s each represent a hydrogen atom, methyl, or phenyl and may be the same or different as long as at least one of R³s is methyl), i.e., the block copolymer (A) including the monomer exemplified below as the acrylate constituting the acrylic polymer block (a), is subjected to cyclization by melt-kneading preferably at a temperature of 180° C. to 300° C., and thereby the unit (c1) can be introduced. At a temperature lower than 180° C., an acid anhydride group may be not sufficiently produced, while at a temperature higher than 300° C., the acrylic block copolymer (A) including the monomer exemplified below as the acrylate constituting the acrylic polymer block (a) may be decomposed.

The unit represented by formula (2) undergoes elimination and cyclization with the adjacent ester unit at a high temperature to produce, for example, a six-membered ring acid anhydride group (refer to, for example, Hatada, et al., J. M. S. PURE APPL. CHEM., A30 (9&10), PP. 645-667 (1993)). According to this document, a polymer having a bulky ester unit and β-hydrogen generally produces a carboxyl group by decomposition of the ester unit at a high temperature, and then undergoes cyclization to produce, for example, a six-membered ring acid anhydride group. By using this process, an acid anhydride group can be easily introduced in the acrylic block copolymer (A). Examples of a monomer for forming the unit represented by formula (2) include, but are not limited to, tert-butyl acrylate, isopropyl acrylate, α,α-dimethylbenzyl acrylate, α-methylbenzyl acrylate, tert-butyl methacrylate, isopropyl methacrylate, α,α-dimethylbenzyl methacrylate, and α-methylbenzyl methacrylate. Among these compounds, tert-butyl acrylate and tert-butyl methacrylate are preferred in view of easy availability, ease of polymerization, and ease of the production of an acid anhydride group.

A process for introducing the carboxyl group-containing unit (c2) is not particularly limited, and various processes can be applied. However, the carboxyl group-containing unit (c2) is preferably produced by appropriately controlling the heating temperature and time in the process for introducing the acid anhydride group-containing unit (c1) into the acrylic block copolymer (A) according to the type and content of the unit represented by formula (2). This is because the reactive sites of the acrylic block copolymer (A) can be easily controlled, and the carboxyl group-containing unit (c2) can be easily introduced in the acrylic block copolymer (A).

From the viewpoint of the above-mentioned introduction process, therefore, the carboxyl group-containing unit (c2) is preferably contained in the same block as that containing the acid anhydride group-containing unit (c1). From the viewpoint of heat resistance and cohesive force, the carboxyl group-containing unit (c2) is more preferably contained in the methacrylic polymer block (b). This is because when the carboxyl group-containing unit (c2) having high Tg and cohesive force is introduced in the methacrylic polymer block (b) serving as a hard segment, rubber elasticity can be expressed at a high temperature. From the viewpoint of compatibility with the compatibilizer (C), the carboxyl group-containing unit (c2) is preferably contained in the acrylic polymer block (a).

<(B) Olefin Thermoplastic Elastomer>

The olefin thermoplastic elastomer (B) is not particularly limited, but a combination of a polyolefin including a thermoplastic polyolefin homopolymer or copolymer and a completely or partially crosslinked olefin rubber or acrylonitrile-butadiene rubber (NBR) can be preferably used.

Examples of the polyolefin include thermoplastic crystalline polyolefin homopolymers and copolymers. In particular, a polyolefin mainly composed of polypropylene is preferred, and a polypropylene copolymer containing ethylene is more preferred for improving low-temperature characteristics.

Examples of the olefin rubber include butyl rubber, ethylene-propylene rubber, and the like. Among these rubbers, ethylene-propylene rubber and EPDM rubber which is a nonconjugated diene terpolymer are preferred because of the excellent low-temperature characteristics. As the olefin thermoplastic elastomer (A), an olefin resin containing dynamically crosslinked EPDM rubber or NBR is particularly preferred.

In addition, a stabilizer (anti-aging agent, photostabilizer, ultraviolet absorber, or the like), a flexibilizer, a plasticizer, an inorganic filler, an organic filler, a flame retardant, a releasing agent, an antistatic agent, an antimicrobial-antifungal agent, and the like may be added according to required characteristics. The additives used may be properly selected according to required physical properties and processability.

In the present invention, the olefin thermoplastic elastomer (B) used preferably has a Shore A hardness at 23° C. of 50 to 90, particularly 65 to 85. Such an olefin thermoplastic elastomer is marketed as a trade name, for example, Santoprene or GEOLAST (manufactured by Advanced Elastomer Systems), and is easily available from the market.

<(C) Compatibilizer>

The compatibilizer used in the present invention is not particularly limited, but an olefin thermoplastic resin (modified polyolefin) containing an epoxy group reactive to the unit (c) such as polymethacrylic anhydride in the acrylic block copolymer (A) is preferred for satisfactorily compatibilizing the acrylic block copolymer (A) and the olefin thermoplastic elastomer (B). Examples of such an olefin thermoplastic resin include commercially available ethylene-glycidyl methacrylate copolymers, copolymers of methyl acrylate-containing ethylene and glycidyl methacrylate, and glycidyl methacrylate-grafted polypropylenes. The content of glycidyl methacrylate in the modified polyolefin resin is preferably 0.05% by weight to 50% by weight and more preferably 0.1% by weight to 20% by weight. When the content of glycidyl methacrylate is less than 0.05% by weight, compatibility between the acrylic block copolymer (A) and the olefin thermoplastic elastomer (B) may becomes unsatisfactory, and tensile strength or the like may degrade. When the content of glycidyl methacrylate exceeds 50% by weight, the cohesiveness of the acrylic block copolymer (A) and the olefin thermoplastic elastomer (B) may be excessively increased to decrease tensile elongation. The modified polyolefin resin is easily available from the market as a trade name, for example, Bondfast (Sumitomo Chemical Co., Ltd.), Modiper (Nippon Oil and Fats Co., Ltd.), or the like.

<(D) Polypropylene Homopolymer>

The polypropylene homopolymer used in the present invention is not particularly limited, but compression set and oil resistance can be improved by adding an appropriate amount of the polypropylene homopolymer to a thermoplastic elastomer composition including the acrylic block copolymer (A), the olefin thermoplastic elastomer (B), and the compatibilizer (C). The adding amount is 90 parts by weight or less, preferably 80 parts by weight or less, and more preferably 70 parts by weight or less relative to 100 parts by weight of the acrylic block copolymer (A). When the adding amount exceeds 90 parts by weight, the compression set of a molded product undesirably decreases.

<Thermoplastic Elastomer Composition>

The thermoplastic elastomer composition of the present invention contains the acrylic block copolymer (A) and the olefin thermoplastic elastomer (B) or the acrylic block copolymer (A), the olefin thermoplastic elastomer (B), and the compatibilizer (C). The mixing amount of each component may be appropriately determined according to the characteristics of a product. For example, in an automobile seal product such as a constant-velocity joint boot for automobiles, the content of the olefin thermoplastic elastomer (B) is preferably 50 to 600 parts by weight, more preferably 200 to 600 parts by weight, and particularly preferably 400 parts by weight, and the content of the compatibilizer (C) is preferably 5 to 50 parts by weight, relative to 100 parts by weight of the acrylic block copolymer (A). At each of the contents within the above range, a molded product having high heat resistance, oil resistance, tensile properties, and dimensional properties in injection molding can be obtained.

The thermoplastic elastomer composition may be prepared by charging the weighed amounts of the acrylic block copolymer (A), the olefin thermoplastic elastomer (B), and the compatibilizer (C) in a molding machine before actual molding. However, from the viewpoint of handling and kneading uniformity, the composition is preferably pelletized before molding. The pelletization will be described below.

A process for pelletizing the thermoplastic elastomer composition of the present invention is not particularly limited, but the composition can be formed in pellets by mechanically kneading under heating at a proper temperature using a known apparatus such as Banbury mixer, a roll mill, a kneader, or a single-screw or multi-screw extruder.

The kneading temperature may be controlled according to the melting temperatures of the acrylic block copolymer (A), olefin thermoplastic elastomer (B), and compatibilizer (C) used. For example, the pelletization can be performed by melt-kneading at 180° C. to 300° C.

The composition of the present invention may further contain a stabilizer (anti-aging agent, photostabilizer, ultraviolet absorber, or the like), a flexibilizer, a flame retardant, a releasing agent, an antistatic agent, an antimicrobial-antifungal agent, and the like. The additives used may be appropriately selected according to required physical properties and processability.

Examples of a stabilizer (anti-aging agent, photostabilizer, ultraviolet absorber, or the like) include, but are not limited to, the following compounds:

Examples of the anti-aging agent include amine-type anti-aging agents, such as phenyl α-naphthylamine (PAN), octyldiphenylamine, N,N′-diphenyl-p-phenylenediamine (DPPD), N,N′-di-β-naphthyl-p-phenylenediamine (DNPD), N-(1,3-dimethylbutyl)-N′-phenyl-p-phenylenediamine, N-phenyl-N′-isopropyl-p-phenylenediamine (IPPN), N,N′-diallyl-p-phenylenediamine, phenothiazine derivatives, diallyl-p-phenylenediamine mixtures, alkylated phenylenediamine, 4,4′-α,α-dimethylbenzyldiphenylamine, p,p-toluenesulfonylaminodiphenylamine, N-phenyl-N′-(3-methacryloyloxy-2-hydropropyl)-p-phenylenediamine, diallylphenylenediamine mixtures, diallyl-p-phenylenediamine mixtures, N-(1-methylheptyl)-N-phenyl-p-phenylenediamine, and diphenylamine derivatives; imidazole-type anti-aging agents, such as 2-mercaptobenzoimidazole (MBI); phenol-type anti-aging agents, such as 2,6-di-tert-butyl-4-methylphenol; phosphate-type anti-aging agents, such as nickel diethyldithiocarbamate; and secondary anti-aging agents, such as triphenylphosphite.

Examples of the photostabilizer and the ultraviolet absorber include 4-tert-butylphenyl salicylate, 2,4-dihydroxylbenzophenone, 2,2′-dihydroxy-4-methoxybenzophenone, ethyl-2-cyano-3,3′-diphenyl acrylate, 2-ethylhexyl-2-cyano-3,3′-diphenyl acrylate, 2-hydroxy-5-chlorobenzophenone, 2-hydroxy-4-methoxybenzophenone-2-hydroxy-4-octoxybenzophenone, monoglycol salicylate, oxalic amide, and 2,2′,4,4′-tetrahydroxybenzophenone. These stabilizers may be used alone or in combination of two or more.

Examples of the flexibilizer include a plasticizer, a softener, oligomers, oil (animal oil, vegetable oil, and the like), petroleum fractions (kerosene, light oil, heavy oil, naphtha, and the like), which are generally mixed in thermoplastic resins and rubbers. The flexibilizer used preferably has excellent affinity for the acrylic block copolymer (A), the olefin thermoplastic elastomer (B), and the compatibilizer (C). In particular, a low-volatile plasticizer with a low heating loss, such as an adipic acid derivative, a phthalic acid derivative, a glutaric acid derivative, a trimellitic acid derivative, a pyromellitic acid derivative, a polyester plasticizer, a glycerin derivative, an epoxy derivative polyester polymer-type plasticizer, or a polyether polymer-type plasticizer is preferably used.

Examples of the softener include process oils, such as petroleum process oils, e.g., paraffinic oil, naphthenic process oil, and aromatic process oil.

Examples of the plasticizer include, but are not limited to, phthalic acid derivatives, such as dimethyl phthalate, diethyl phthalate, di-n-butyl phthalate, di-(2-ethylhexyl) phthalate, diheptyl phthalate, diisodecyl phthalate, di-n-octyl phthalate, diisononyl phthalate, ditridecyl phthalate, octyldecyl phthalate, butylbenzyl phthalate, and dicyclohexyl phthalate; isophthalic acid derivatives, such as dimethyl isophthalate; tetrahydrophthalic acid derivatives, such as di-(2-ethylhexyl) tetrahydrophthalate; adipic acid derivatives, such as dimethyl adipate, dibutyl adipate, di-n-hexyl adipate, di-(2-ethylhexyl) adipate, dioctyl adipate, isonoyl adipate, diisodecyl adipate, and dibutyldiglycol adipate; azelaic acid derivatives, such as di-2-ethylhexyl azelate; sebacic acid derivatives, such as dibutyl sebacate; dodecanoic diacid derivatives; maleic acid derivatives, such as dibutyl maleate and di-2-ethylhexl maleate; fumaric acid derivatives, such as dibutyl fumarate; p-oxybenzoic acid derivatives, such as 2-ethylhexyl p-oxybenzoate; trimellitic acid derivatives, such as tris-2-ethylhexyl trimellitate; pyromellitic acid derivatives; citric acid derivatives, such as acetyltributyl citrate; itaconic acid derivatives; oleic acid derivatives; ricinoleic acid derivatives; stearic acid derivatives; other fatty acid derivatives; sulfonic acid derivatives; phosphoric acid derivatives; glutaric acid derivatives; polyester plasticizers each including a polymer of a dibasic acid such as adipic acid, azelaic acid, or phthalic acid, and glycol or a monohydric alcohol; glycol derivatives; glycerin derivatives; paraffin derivatives, such as chlorinated paraffin; epoxy derivative polyester polymer-type plasticizers; polyether polymer-type plasticizers; carbonate derivatives, such as ethylene carbonate and propylene carbonate; and benzenesulfonic acid derivatives, such as N-butylbenzenamide. Plasticizers widely commercially available as plasticizers for rubbers or thermoplastic resins can be used.

Examples of commercially available plasticizers include Thiokol TP (manufactured by Morton Inc.), Adekacizer 0-130P, C-79, UL-100, P-200, and RS-735 (manufactured by Asahi Denka Kogyo Co.), Sansocizer N-400 (manufactured by New Japan Chemical Co., Ltd.), BM-4 (manufactured by Daihachi Chemical Industry Co., Ltd.), EHPB (manufactured by Ueno Fine Chemicals Industry), and UP-1000 (manufactured by To a Gosei Chemical Industry Co., Ltd.).

Examples of oil include vegetable oils, such as castor oil, cottonseed oil, linseed oil, rapeseed oil, soybean oil, palm oil, coconut oil, peanut oil, pine oil, tall oil, sesame oil, and camellia oil.

Other examples of the flexibilizer include polybutene oil, spindle oil, machine oil, and tricresyl phosphate.

Examples of the flame retardant include, but are not limited to, triphenyl phosphate, tricresyl phosphate, decabromobiphenyl, decabromobiphenyl ether, and antimony trioxide. These compounds may be used alone or in combination of two or more.

The composition of the present invention can be molded by any molding process, such as extrusion molding, compression molding, blow molding, calendering, vacuum molding, foaming, injection molding, or injection blow molding. Among these processes, injection molding is preferred from the viewpoint of simplicity.

For example, in the injection molding, conditions for molding the thermoplastic elastomer composition of the present invention to form a molded product generally include a cylinder temperature of 150° C. to 230° C., a nozzle temperature of 180° C. to 240° C., a low injection rate, a cooling time of 30 seconds, and a mold temperature of 30° C. to 80° C.

The products formed by the above-mentioned process according to the present invention have excellent low-temperature characteristics, oil resistance, heat resistance, weather resistance, mechanical properties, and fatigue strength, and can be suitably used as seal products for automobiles. For example, the products are excellent in simplification of the molding process and recycling property, as compared with conventional vulcanized rubber systems.

### EXAMPLES

The composition of the present invention will be described in further detail below on the basis of examples, but the present invention is not limited to these examples.

Hereinafter, EA, BA, MEA, MMA, TBMA, TBA, and 2EHA denote ethyl acrylate, n-butyl acrylate, 2-methoxyethyl acrylate, methyl methacrylate, tert-butyl methacrylate, tert-butyl acrylate, and 2-ethylhexyl acrylate, respectively.

The molecular weight of a polymer was determined in terms of polystyrene by GPC measurement using the GPC analyzer below, chloroform as a mobile phase, and a polystyrene gel column.

<Test Method>

(Molecular Weight)

The molecular weight of an acrylic block copolymer was determined in terms of polystyrene by measurement using the GPC analyzer (system: GPC system manufactured by Waters Corporation, and column: Shodex K-804 (polystyrene gel) manufactured by Showa Denko K. K.), chloroform as a mobile phase, and a polystyrene gel column.

(Analysis of Conversion to Six-Membered Ring Acid Anhydride Group)

The reaction of conversion to a six-membered ring acid anhydride group in an acrylic block copolymer was confirmed by infrared spectrometry (using FTIR-8100 manufactured by Shimadzu Corporation) and nuclear magnetic resonance analysis (using AM400 manufactured by BRUKER).

As a solvent for nuclear magnetic resonance analysis, deuterochloroform was used as a solvent for measuring a block with a carboxylate structure together with a block with a six-membered ring acid anhydride structure.

(Hardness)

Hardness (JIS A) at 23° C. was measured according to JIS K6301.

(Oil Resistance)

According to ASTM D638, a molded product of the composition was immersed in ASTM oil No. 3 kept at 120° C. or 140° C. for 72 hours to measure a rate of weight change (% by weight).

(Dimensional Properties of Boot)

The height of a quadruple-bellows boot molding (mold: 107 mm in height) formed by injection molding was measured. When the measured height was close to the dimension of the mold, the dimensional properties was decided as good.

(Low-Temperature Brittle Temperature)

According to JIS K7216, a molded sheet of 2 mm in thickness was cut into a size of 38 mm×6 mm and measured with respect to the low-temperature brittle temperature with a low-temperature brittle temperature measuring device, Standard Model S (dry ice type) (manufactured by Toyo Seiki Kogyo Co., Ltd.), using a dry ice-methanol mixture as a refrigerant.

(Tensile Properties)

The tensile properties were measured using Autograph AG-10TB model manufactured by Shimadzu Corporation according to the method described in JIS k7113. The measurement was carried out with n=3, and averages of strength (MPa), elastic modulus (MPa), and elongation at break of a test piece were used. The test piece had the shape of Test Piece No. 2(1/3) and a thickness of about 2 mm. The test was conducted at 23° C. and a test speed of 500 mm/min. In principle, the test piece was conditioned at a temperature of 23° C.±2° C. and a relative humidity of 50±5% for 48 hours or more before the test.

(Compression Set)

According to JIS K6301, a cylindrical molded product was maintained with a compression rate of 25% at 120° C. for 72 hours and allowed to stand at room temperature for 30 minutes. Then, the thickness of the molded product was measured to calculate a degree of residual strain. A compression set of 0% means complete recovery of strain, and a compression set of 100% means no recovery of strain.

(Fatigue Strength)

According to JIS K6260, a test piece having a length of 140 mm, a width of 25 mm, a central groove radius of 2.38 mm, and a thickness of 6.3 mm was bent 300 times per minute at 100° C. using a bending tester having a moving distance of 57 mm. The number of the times of bending until a crack of 1 mm or more occurred was measured.

### Production Examples of Acrylic Block Copolymer

### Production Example 1-1

### Synthesis of Block Copolymer 2A40T6.5

In order to obtain 2A40T6.5, the following operation was carried out:

In a 500 L reactor with a stirrer capable of heating C and cooling, a polymerization container was purged with nitrogen, and then 840.1 g (5.9 mol) of copper bromide and 12 L of acetonitrile (bubbled with nitrogen) were added to the container. After stirring under heating at 70° C. for 30 minutes, 421.7 g (1.17 mol) of diethyl 2,5-dibromoadipate serving as an initiator, 41.4 L (288.9 mol) of BA, and 18.6 L (144.5 mol) of MEA were added. The resultant mixture was stirred under heating at 85° C., and 0.1 L (0.59 mol) of diethylenetriamine was added as a ligand to initiate polymerization.

After the start of polymerization, about 0.2 ml of a polymerization solution was sampled at a predetermined time interval, and the BA conversion rate was determined by gas chromatographic analysis using the sampled solution. The polymerization rate was controlled by adding diethylenetriamine as needed. At the BA conversion rate of 94% and the MEA conversation rate of 96%, 24.9 L (153.8 mol) of TBMA, 24.7 L (230.8 mol) of MMA, 580 g (5.9 mol) of copper chloride, 1.2 L (9.1 mol) of butyl acetate, and 122.8 L of toluene (bubbled with nitrogen) were added. Similarly, the TBMA and MMA conversion rates were determined. At the TBMA conversion rate of 61% and the MMA conversion rate of 56%, 80 L of toluene was added, and the reactor was cooled in a water bath to terminate reaction.

The reaction solution was diluted with 115 L of toluene, and 1,337 g of p-toluenesulfonic acid monohydrate was added, followed by stirring at room temperature for 3 hours. Then, the solid was removed with a bag filter (manufactured by HAYWARD Corporation). Then, 1,642 g of an adsorbent (trade name, Kyowaad 500SH; manufactured by Kyowa Chemical Industry Co., Ltd.) was added to the resulting polymer solution, followed by further stirring at room temperature for 3 hours. The adsorbent was filtered off with a bag filter to obtain a colorless transparent polymer solution. The resultant solution was dried with a horizontal evaporator (heating surface area 1 mm²) to remove the solvent and residual monomers, thereby obtaining target block copolymer 2A40T6.5.

The GPC analysis of resultant block copolymer 2A40T6.5 showed a number-average molecular weight (Mn) of 93,700 and a molecular weight distribution (Mw/Mn) of 1.36.

### Production Example 1-2

### Reaction of Conversion to Six-Membered Ring Acid Anhydride in Block Copolymer 2A40T6.5 and Characteristic Evaluation

First, 700 g of the block copolymer (2A40T6.5) produced in Production Example 1-1 and 1.4 g of a phenolic antioxidant (trade name, Irganox 1010 manufactured by Ciba Specialty Chemicals Co., Ltd.) were melt-kneaded at 70 rpm for 20 minutes using a pressure kneader (DS1-5 MHB-E model kneader manufactured by Moriyama) set at 240° C. to obtain the target block copolymer containing a six-membered ring acid anhydride group (the resultant polymer is referred to as “2A40AN6.5” hereinafter). Also, the massive polymer produced by the pressure kneader was crushed in a frozen state by a crusher using liquid nitrogen to obtain pellets of the block copolymer.

The conversion of a tert-butyl ester portion to a six-membered ring acid anhydride group could be confirmed by IR (infrared absorption spectrum) analysis and ¹³C-NMR (nuclear magnetic resonance spectrum) analysis.

Namely, in the IR analysis, the conversion could be confirmed by the appearance of an absorption spectrum at about 1800 cm⁻¹ due to the acid anhydride group after the conversion. In the ¹³C-NMR analysis, the conversion could be confirmed by the disappearance of a signal at 82 ppm due to the methine carbon of a tert-butyl group and a signal at 28 ppm due to the methyl carbon thereof after the conversion.

### Production Example 2-1

### Synthesis of Block Copolymer 3A50T6.1

In a 500 L reactor with a stirrer capable of heating and cooling, 634 g (1.76 mol) of diethyl 2,5-dibromoadipate, 33.8 L (235.5 mol) of BA, 32.1 L (296 mol) of EA, and 18.2 L (141.3 mol) of MEA were charged and polymerized. At the BA conversion rate of 96%, the EA conversion rate of 95%, and the MEA conversion rate of 97%, 33.4 L (206 mol) of TBMA and 22.0 L (206.1 mol) of MMA were added. At the TBMA conversion rate of 91% and the MMA conversion rate of 94%, the reaction was terminated. The other procedures were the same as in Production Example 1. As a result, the target acrylic block copolymer (3A50T6.1) was obtained.

The GPC analysis of the resultant block copolymer (3A50T6.1) showed a number-average molecular weight (Mn) of 104,400 and a molecular weight distribution (Mw/Mn) of 1.31.

### Production Example 2-2

### Reaction of Conversion to Six-Membered Ring Acid Anhydride in Block Copolymer 3A50T6.1 and Characteristic Evaluation

First, 0.6 part by weight of Irganox 1010 (manufactured by Ciba Specialty Chemicals Co., Ltd.) was mixed relative to 100 parts by weight of the acrylic block copolymer (3A50T6.1) produced in Production Example 2-1, and the resultant mixture was extrusion-kneaded at a rotational speed of 300 rpm at a temperature of 240° C. using a vented double-screw extruder (44 mm, L/D=42.25) (manufactured by Japan Steel Works, Ltd.) to obtain the target acrylic block copolymer containing an acid anhydride group (the resultant polymer is referred to as 113A50AN6.1 hereinafter).

The GPC analysis of the resultant block copolymer (3A50AN6.1) showed a number-average molecular weight (Mn) of 93,700 and a molecular weight distribution (Mw/Mn) of 1.36.

Also, an underwater cut pelletizer (CLS-6-8.1 COMPACT LAB SYSTEM manufactured by GALA INDUSTRIES INC.) was connected to the tip of the double-screw extruder, and Alflow H-50ES (manufactured by NOF Corporation) was added as an anti-adhesion agent to circulating water of the underwater cut pelletizer, thereby obtaining non-adhesive spherical pellets.

### Production Example 3-1

### Synthesis of Block Copolymer BA50T7

In a 500 L reactor with a stirrer capable of heating and cooling, 408 g (1.13 mol) of diethyl 2,5-dibromoadipate and 74 L (516 mol) of BA were charged and polymerized. At the BA conversion rate of 95%, 28.2 L (174 mol) of TBMA and 18.7 L (174 mol) of MMA were added. At the TBMA conversion rate of 66.0% and the MMA conversion rate of 58%, the reaction was terminated. The other procedures were the same as in Production Example 1. As a result, the target acrylic block copolymer (BA50T7) was obtained.

The GPC analysis of the resultant acrylic block copolymer (BA50T7) showed a number-average molecular weight (Mn) of 104,800 and a molecular weight distribution (Mw/Mn) of 1.25.

### Production Example 3-2

### Reaction of Conversion to Six-Membered Ring Acid Anhydride in Block Copolymer BA50T7 and Characteristic Evaluation

First, 0.6 part by weight of Irganox 1010 (manufactured by Ciba Specialty Chemicals Co., Ltd.) was mixed relative to 100 parts by weight of the acrylic block copolymer (BA50T7) produced in Production Example 3-1, and the other procedures were the same as in Production Example 2-2. As a result, the target acrylic block copolymer containing a six-membered ring acid anhydride group (the resultant polymer is referred to as “BA50AN7” hereinafter) was obtained.

The conversion of a tert-butyl ester portion to a six-membered ring acid anhydride was confirmed by the same analyses as in Production Example 1-2, and the same results as in Production Examples 1-2 were obtained.

### Production Example 4-1

### Synthesis of Block Copolymer 2E/BA50T8

In a 500 L reactor with a stirrer capable of heating and cooling, 377 g (1.05 mol) of diethyl 2,5-dibromoadipate, 47.3 L (330 mol) of BA, and 20.7 L of 2EHA were charged and polymerized. At the BA conversion rate of 95% and the 2EHA conversion rate of 95%, 10.7 L (78.6 mol) of TBMA and 8.4 L (78.6 mol) of MMA were added. At the TBMA conversion rate of 76.1% and the MMA conversion rate of 72.2%, the reaction was terminated. The other procedures were the same as in Production Example 1. As a result, the target acrylic block copolymer (2E/BA50T8) was obtained.

The GPC analysis of the resultant acrylic block copolymer (2E/BA50T8) showed a number-average molecular weight (Mn) of 91,800 and a molecular weight distribution (Mw/Mn) of 1.29.

### Production Example 4-2

### Reaction of Conversion to Six-Membered Ring Acid Anhydride in Block Copolymer 2E/BA50T8 and Characteristic Evaluation

First, 0.6 part by weight of Irganox 1010 (manufactured by Ciba Specialty Chemicals Co., Ltd.) was mixed relative to 100 parts by weight of the acrylic block copolymer (2E/BA50T8) produced in Production Example 4-1, and the other procedures were the same as in Production Example 2-2. As a result, the target acrylic block copolymer containing a six-membered ring acid anhydride group (the resultant polymer is referred to as “2E/BA50AN8” hereinafter) was obtained.

The conversion of a tert-butyl ester portion to a six-membered ring acid anhydride was confirmed by the same analyses as in Production Example 1-2, and the same results as in Production Examples 1-2 were obtained.

### Example 1

First, 1,076.9 g of the acrylic block copolymer (2A40AN6.5) produced in Production Example 1-2, 2,153.8 g of an olefin thermoplastic elastomer (trade name, Santoprene 111-80; manufactured by Advanced Elastomer Systems), and 269.2 g of a compatibilizer (ethylene-glycidyl methacrylate-methacrylate) were sufficiently mixed by hand blending so as to be uniformly dispersed. The resultant mixture was melt-kneaded by a vented double-screw extruder, TEX30HSS-25.5PW-2V, (manufactured by Japan Steel Works, Ltd.) under kneading conditions in which C1-C3 was 100° C., C4 was 180° C., C5 was 180° C., C6 was 200° C., C7 was 220° C., a die head was 220° C., and the rotational speed was 150 rpm. The extruded strand was pelletized with a pelletizer, SCF-100, (manufactured by Isuzu Kakoki Co., Ltd.), for facilitating injection molding. The resultant pellets were dried at 80° C. for 3 hours or more and then injection-molded by an injection molding machine, J150E-P (manufactured by Japan Steel Works, Ltd.), with a mold clamping force of 150 tons under conditions in which the cylinder temperature was 150° C., the nozzle temperature was 180° C., the injection rate was 10%, the mold release air pressure was 5 kg/cm² (0.49 MPa), the cooling time was 30 seconds, and the mold temperature was 40° C. As a result, a quadruple-bellows boot molding was obtained, and the height of the molding was measured.

The pellets were also injection-molded by an injection molding machine, IS-80EPN (manufactured by Toshiba Machine Co., Ltd.), with a mold clamping force of 80 tons under conditions in which the cylinder temperature was 150° C., the nozzle temperature was 180° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured. The results are shown in Table 1.

### Example 2

First, 1,076.9 g of the acrylic block copolymer (3A50AN6.1) produced in Production Example 2-2, 2,153.8 g of an olefin thermoplastic elastomer (trade name, Santoprene 111-73; manufactured by Advanced Elastomer Systems), and 269.2 g of a compatibilizer (ethylene-glycidyl methacrylate-methacrylate) were sufficiently mixed by hand blending so as to be uniformly dispersed. The resultant mixture was melt-kneaded by a vented double-screw extruder, TEX30HSS-25.5PW-2V, (manufactured by Japan Steel Works, Ltd.) under kneading conditions in which C1-C3 was 100° C., C4 was 180° C., C5 was 180° C., C6 was 200° C., C7 was 220° C., a die head was 220° C., and the rotational speed was 150 rpm. The extruded strand was pelletized with a pelletizer, SCF-100, (manufactured by Isuzu Kakoki Co., Ltd.), for facilitating injection molding. The resultant pellets were dried at 80° C. for 3 hours or more and then injection-molded by an injection molding machine, J150E-P (manufactured by Japan Steel Works, Ltd.), with a mold clamping force of 150 tons under conditions in which the cylinder temperature was 150° C., the nozzle temperature was 180° C., the injection rate was 10%, the mold release air pressure was 5 kg/cm² (0.49 MPa), the cooling time was 30 seconds, and the mold temperature was 40° C. As a result, a quadruple-bellows boot molding was obtained, and the height of the molding was measured.

The pellets were also injection-molded by an injection molding machine, IS-80EPN (manufactured by Toshiba Machine Co., Ltd.), with a mold clamping force of 80 tons under conditions in which the cylinder temperature was 150° C., the nozzle temperature was 180° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured. The results are shown in Table 1.

### Example 3

First, 975.6 g of the acrylic block copolymer (2A40AN6.5) produced in Production Example 1-2, 3,902.4 g of an olefin thermoplastic elastomer (trade name, Santoprene 111-80; manufactured by Advanced Elastomer Systems), and 122.0 g of a compatibilizer (ethylene-glycidyl methacrylate-methacrylate) were sufficiently mixed by hand blending so as to be uniformly dispersed. The resultant mixture was melt-kneaded by a vented double-screw extruder, TEX30HSS-25.5PW-2V, (manufactured by Japan Steel Works, Ltd.) under kneading conditions in which C1-C3 was 100° C., C4 was 180° C., C5 was 180° C., C6 was 200° C., C7 was 220° C., a die head was 220° C., and the rotational speed was 150 rpm. The extruded strand was pelletized with a pelletizer, SCF-100, (manufactured by Isuzu Kakoki Co., Ltd.), for facilitating injection molding. The resultant pellets were dried at 80° C. for 3 hours or more and then injection-molded by an injection molding machine, J150E-P (manufactured by Japan Steel Works, Ltd.), with a mold clamping force of 150 tons under conditions in which the nozzle temperature was 180° C., the injection rate was 10%, the mold release air pressure was 5 kg/cm² (0.49 MPa), the cooling time was 30 seconds, and the mold temperature was 40° C. As a result, a quadruple-bellows boot molding was obtained, and the height of the molding was measured.

The pellets were also injection-molded by an injection molding machine, IS-80EPN (manufactured by Toshiba Machine Co., Ltd.), with a mold clamping force of 80 tons under conditions in which the cylinder temperature was 150° C., the nozzle temperature was 180° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured. The results are shown in Table 1.

### Comparative Example 1

First, pellets of an olefin thermoplastic elastomer (trade name, Santoprene 111-80; manufactured by Advanced Elastomer Systems) were dried at 80° C. for 3 hours or more and then injection-molded by an injection molding machine, J150E-P (manufactured by Japan Steel Works, Ltd.), with a mold clamping force of 150 tons under conditions in which the nozzle temperature was 180° C., the injection rate was 10%, the mold release air pressure was 5 kg/cm² (0.49 MPa), the cooling time was 15 seconds, and the mold temperature was 40° C. As a result, a quadruple-bellows boot molding was obtained, and the height of the molding was measured. The pellets were also injection-molded by an injection molding machine, IS-80EPN (manufactured by Toshiba Machine Co., Ltd.), with a mold clamping force of 80 tons under conditions in which the cylinder temperature was 150° C., the nozzle temperature was 180° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured. The results are shown in Table 1.

### Comparative Example 2

First, pellets of an olefin thermoplastic elastomer (trade name, Santoprene 111-73; manufactured by Advanced Elastomer Systems) were dried at 80° C. for 3 hours or more and then injection-molded by an injection molding machine, J150E-P (manufactured by Japan Steel Works, Ltd.), with a mold clamping force of 150 tons under conditions in which the cylinder temperature was 150° C., the nozzle temperature was 180° C., the injection rate was 10%, the mold release air pressure was 5 kg/cm² (0.49 MPa), the cooling time was 15 seconds, and the mold temperature was 40° C. As a result, a quadruple-bellows boot molding was obtained, and the height of the molding was measured. The pellets were also injection-molded by an injection molding machine, IS-80EPN (manufactured by Toshiba Machine Co., Ltd.), with a mold clamping force of 80 tons under conditions in which the cylinder temperature was 150° C., the nozzle temperature was 180° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured. The results are shown in Table 1.

TABLE 1

| | | | | Compara- | Compara- |
|---|---|---|---|---|---|
| | Example | Example | Example | tive | tive |
| | 1 | 2 | 3 | Example 1 | Example 2 |
| Hardness | 60 | 64 | 68 | 85 | 75 |
| (JIS-A) | | | | | |
| Oil | 131 | 134 | 139 | 145 | 151 |
| resistance | | | | | |
| (rate of | | | | | |
| weight | | | | | |
| change, %) | | | | | |
| Dimensional | 105 | 108 | 109 | 138 | 131 |
| properties | | | | | |
| (mm) | | | | | |

The results shown in Table 1 (Examples 1, 2, and 3 and Comparative Examples 1 and 2) indicate that the molded products of Examples 1, 2, and 3 each of which was formed using the thermoplastic elastomer composition containing the acrylic block copolymer, the olefin thermoplastic elastomer, and the compatibilizer have excellent oil resistance in spite of having higher flexibility than the molded products of Comparative Examples 1 and 2 each of which was formed using the olefin thermoplastic elastomer alone. Also, the quadruple-bellows boot moldings of Examples 1, 2, and 3 have dimensions close to the dimension of the mold and are thus highly excellent in dimensional properties.

### Examples 4 to 9

First, the acrylic block copolymer (3A50AN6.1) produced in Production Example 2-2, the acrylic block copolymer (BA50AN7) produced in Production Example 3-2, or the acrylic block copolymer (2E/BA50AN8) produced in Production Example 4-2, an olefin thermoplastic elastomer such as an olefin thermoplastic elastomer (trade name, Santoprene 111-73; manufactured by Advanced Elastomer Systems), an olefin thermoplastic elastomer (trade name, Santoprene 111-87; manufactured by Advanced Elastomer Systems), an olefin thermoplastic elastomer (trade name, Santoprene 111-80; manufactured by Advanced Elastomer Systems), or an olefin thermoplastic elastomer (trade name, GEOLAST701-80W183; manufactured by Advanced Elastomer Systems), a polyolefin (Mitsui Polypro J105G; manufactured by Mitsui Chemicals, Inc.), and a compatibilizer (trade name, Bondfast 7M manufactured by Sumitomo Chemical Co., Ltd.) were sufficiently mixed at each of the ratios shown in Table 2 by hand blending so as to be uniformly dispersed. Each resultant mixture was melt-kneaded by a vented double-screw extruder, TEX30HSS-25.5PW-2V, (manufactured by Japan Steel Works, Ltd.) under kneading conditions in which C₁-C₃ was 80° C., C4 was 100° C., C5 was 120° C., C6 was 180° C., C7 was 200° C., a die-head was 220° C., and the rotational speed was 250 rpm. The extruded strand was pelletized with a pelletizer, SCF-100, (manufactured by Isuzu Kakoki Co., Ltd.), for facilitating injection molding. The resultant pellets were dried at 80° C. for 3 hours or more and then injection-molded by an injection molding machine, JLSOE-P (manufactured by Japan Steel Works, Ltd.), with a mold clamping force of 150 tons under conditions in which the cylinder temperature was 180° C., the nozzle temperature was 230° C., the injection rate was 10%, the mold release air pressure was 5 kg/cm² (0.49 MPa), the cooling time was 30 seconds, and the mold temperature was 40° C. As a result, a quadruple-bellows boot molding was obtained, and the height of the molding was measured.

The pellets were also injection-molded by an injection molding machine, IS-80EPN (manufactured by Toshiba Machine Co., Ltd.), with a mold clamping force of 80 tons under conditions in which the cylinder temperature was 180° C., the nozzle temperature was 230° C., the injection rate was 10%, the cooling time was 30 seconds, and the mold temperature was 40° C. to obtain a plate of 120×120×2 mm. The tensile properties, oil resistance, and low-temperature brittleness of the plate were measured, and the hardness of a laminate of three plates was measured. Furthermore, a cylindrical molded product having a thickness of 12.7 mm and a diameter of 29.0 mm was formed and measured with respect to compression set. Furthermore, a shape of 140×25×6.3 mm for testing flex cracking which had a central groove radius of 2.38 mm was formed and measured with respect to fatigue strength. The results are shown in Table 2.

### Comparative Example 3

First, pellets of the acrylic block copolymer (3A50AN6.1) produced in Production Example 2-2 were dried at 80° C. for 3 hours or more and then injection-molded by an injection molding machine, J150E-P (manufactured by Japan Steel Works, Ltd.), with a mold clamping force of 150 tons under conditions in which the cylinder temperature was 200° C., the nozzle temperature was 240° C., the injection rate was 10%, the mold release air pressure was 5 kg/cm² (0.49 MPa), the cooling time was 15 seconds, and the mold temperature was 40° C. As a result, a quadruple-bellows boot molding was obtained, and the height and fatigue strength of the molding were measured. The pellets were also injection-molded by an injection molding machine, IS-80EPN (manufactured by Toshiba Machine Co., Ltd.), with a mold clamping force of 80 tons under conditions in which the cylinder temperature was 200° C., the nozzle temperature was 240° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured, and the low-temperature brittle temperature, tensile properties, and compression set were measured. The results are shown in Table 2.

### Comparative Examples 4 to 6

First, pellets of an olefin thermoplastic elastomer (trade name, Santoprene 111-73; manufactured by Advanced Elastomer Systems), an olefin thermoplastic elastomer (trade name, Santoprene 111-87; manufactured by Advanced Elastomer Systems), or an olefin thermoplastic elastomer (trade name, Santoprene 111-70; manufactured by Advanced Elastomer Systems) were dried at 80° C. for 3 hours or more and then injection-molded by an injection molding machine, J150E-P (manufactured by Japan Steel Works, Ltd.), with a mold clamping force of 150 tons under conditions in which the cylinder temperature was 180° C., the nozzle temperature was 210° C., the injection rate was 10%, the mold release air pressure was 5 kg/cm² (0.49 MPa), the cooling time was 15 seconds, and the mold temperature was 40° C. As a result, a quadruple-bellows boot molding was obtained, and the height and fatigue strength of the molding were measured. The pellets were also injection-molded by an injection molding machine, IS-80EPN (manufactured by Toshiba Machine Co., Ltd.), with a mold clamping force of 80 tons under conditions in which the cylinder temperature was 180° C., the nozzle temperature was 210° C., the injection rate was 10%, the cooling time was 30 seconds, and the mold temperature was 40° C. to obtain a plate of 120×120×2 mm. The oil resistance of the plate was measured. Furthermore, the hardness of a laminate of three plates was measured, and the low-temperature brittle temperature, tensile properties, and compression set were measured. The results are shown in Table 2.

TABLE 2

| | | | | | Example | | | | | Comparative Example | | | |
|---|---|---|---|---|---|---|---|---|---|---|---|---|---|
| | | | | | 4 | 5 | 6 | 7 | 8 | 3 | 4 | 5 | 6 |
| Composi- | Acrylic block copolymer | | 3A50AN6.1 | | 100 | | | 100 | 100 | 100 | | | |
| tion | | | BA50AN7 | | | 100 | | | | | | | |
| (parts) | | | 2E/BA50AN8 | | | | 100 | | | | | | |
| | Olefin thermoplastic | | Santoprene 111-73 | | 400 | | | 400 | | | 100 | | |
| | elastomer | | Santoprene 111-87 | | | 150 | 125 | | | | | 100 | |
| | | | Santoprene 111-80 | | | | | | 400 | | | | 100 |
| | | | GEOLAST701-80W183 | | | | 25 | | | | | | |
| | Polyolefin | | Mitsui Polypro | | | | | 10 | | | | | |
| | | | J105G | | | | | | | | | | |
| | Compatibilizer | | Ethylene-glycidyl | | 25 | 25 | 5 | 25 | 25 | | | | |
| | | | methacrylate- | | | | | | | | | | |
| | | | methacrylate | | | | | | | | | | |
| Physical | Hardness | | 23° C. | JIS-A | 67 | 70 | 66 | 78 | 82 | 50 | 75 | 88 | 85 |
| proper- | Low-temperature brittle | | | ° C. | −58 | −53 | −58 | −53 | −53 | −29 | −65 | −65 | −65 |
| ties | point | | | | | | | | | | or | or | or |
| | | | | | | | | | | | less | less | less |
| | Tensile | Tensile strength | 23° C. | MPa | 6 | 5 | 6 | 7 | 6 | 10 | 8 | 12 | 8 |
| | properties | at break | | | | | | | | | | | |
| | TD | Elastic modulus | 23° C. | MPa | 13.7 | 15.4 | 12.2 | 16 | 22 | 3.7 | 14.9 | 59.2 | 29.5 |
| | direction | Elongation | 23° C. | % | 472 | 403 | 498 | 472 | 353 | 300 | 575 | 628 | 487 |
| | | between gages for | | | | | | | | | | | |
| | | tensile break | | | | | | | | | | | |

| | | | | | | | | | | | |
|---|---|---|---|---|---|---|---|---|---|---|---|
| Oil resistance (rate of | 120° C., 72 | % | 56 | 51 | 49 | 47 | 46 | 12 | 78 | 69 | 72 |
| weight change) | hr | | | | | | | | | | |
| Compression set | 120° C., 72 | % | 77 | 76 | 73 | 49 | 79 | 94 | 64 | 78 | 75 |
| | hr | | | | | | | | | | |
| Fatigue strength | 100° C. | *) | >5000,000 | — | — | — | — | 10,000 | — | 800,000 | — |
| Dimensional properties | Mold: 107 | mm | 106 | 105 | 106 | 106 | 107 | — | 131 | 142 | 138 |
| (dimension) | | | | | | | | | | | |

*) Number of times of bending

The results shown in Table 2 (Examples 4 to 8 and Comparative Examples 3 to 6) indicate that the molded products of Examples 4, 5, 6, and 8 each of which was formed using the thermoplastic elastomer composition containing the acrylic block copolymer, the olefin thermoplastic elastomer, and the compatibilizer are harder than the molded product of Comparative Example 3 which was formed using the acrylic block copolymer alone. However, the molded products of Examples 4, 5, 6, and 8 have excellent tensile properties and fatigue strength, and also have excellent oil resistance in spite of having higher flexibility than the molded products of Comparative Examples 4 to 6 each of which was formed using the olefin thermoplastic elastomer alone. Also, the quadruple-bellows boot moldings of Examples 4, 5, 6, and 8 have dimensions close to the dimension of the mold and are thus very excellent in dimensional properties, and also excellent in fatigue strength. The results of Example 7 show that the compression set and oil resistance are improved by adding a polypropylene homopolymer.

### INDUSTRIAL APPLICABILITY

Examples of applications of the thermoplastic elastomer composition of the present invention include molded products for automobiles, domestic electric appliances, and office electric appliances. Specific examples of molded products include various oil seals, such as an oil seal and a reciprocating oil seal; various packings, such as a gland packing, a lip packing, and a squeeze packing; various dust covers, such as a suspension dust cover, a suspension tie-rod dust cover, and a stabilizer die-rod dust cover; various boots, such as a steering rack boot, a strut boot, a rack-and-pinion boot, and a constant-velocity joint boot; various gaskets, such as a resin intake manifold gasket, a throttle-body gasket, a power steering vane pump gasket, a head-cover gasket, a water heater self-feeding pump gasket, a filter gasket, a piping joint (ABS & HBB) gasket, a HDD top-cover gasket, a HDD connector gasket, a metal cylinder head gasket, a car cooler compressor gasket, a gasket around an engine, an AT separate plate, and general-purpose gaskets (industrial sawing machine, a nailing machine, and the like); various valves, such as a needle valve, a plunger valve, a water-gas valve, a braking valve, a drink valve, and a safety value for an aluminum electrolytic condenser; various stoppers mainly for buffer function, such as a diaphragm for vacuum booster or water-gas, a seal washer, a bore plug, and a high-precision stopper; precision seal rubbers, such as a plug tube seal, an injection pipe seal, an oil receiver, a brake drum seal, a shading seal, a plug seal, a connector seal, and a keyless entry cover. Other examples include various weather strips, such as an automobile door weather strip; a trunk seal; a glass run channel; and an accelerator pedal. In particular, injection-molded products are useful as molded products for automobiles, domestic electric appliances, or office electric appliances, and particularly useful as automobile constant-velocity joint boots.

1. A thermoplastic elastomer composition comprising:
(A) an acrylic block copolymer; and
(B) an olefin thermoplastic elastomer.

2. The thermoplastic elastomer composition according to claim 1, further comprising (C) a compatibilizer.

3. The thermoplastic elastomer composition according to claim 2, comprising 50 to 600 parts by weight of the olefin thermoplastic elastomer (B) and 5 to 50 parts by weight of the compatibilizer (C) relative to 100 parts by weight of the acrylic block copolymer (A).

4. The thermoplastic elastomer composition according to claim 1, further comprising (D) a polypropylene homopolymer.

5. The thermoplastic elastomer composition according to claim 1, wherein the acrylic block copolymer (A) includes an acrylic polymer block (a) and a methacrylic polymer block (b), and at least one of the polymer blocks has a reactive functional group (c).

6. The thermoplastic elastomer composition according to claim 5, wherein the reactive functional group (c) in the acrylic block copolymer (A) has an acid anhydride group-containing unit (c1) and/or carboxyl group-containing unit (c2) which are represented by formula (1): 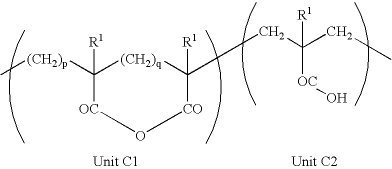
(wherein R¹s are each a hydrogen atom or a methyl group and may be the same or different, p is an integer of 0 or 1, and q is an integer of 0 to 3).

7. The thermoplastic elastomer composition according to claim 6, wherein the acrylic block copolymer (A) contains 0.1 to 50% by weight of the carboxyl group-containing unit (c2) relative to the whole of the acrylic block copolymer (A).

8. The thermoplastic elastomer composition according to claim 1, wherein the acrylic block copolymer (A) contains 50 to 90% by weight of the acrylic polymer block (a) and 50 to 10% by weight of the methacrylic polymer block (b).

9. The thermoplastic elastomer composition according to claim 1, wherein the acrylic block copolymer (A) is a block copolymer produced by atom transfer radical polymerization.

10. The thermoplastic elastomer composition according to claim 1, wherein the olefin thermoplastic elastomer (B) is produced by dynamic crosslinking of EPDM rubber or acrylonitrile-butadiene rubber in an olefin resin.

11. The thermoplastic elastomer composition according to claim 2, wherein the compatibilizer (C) is an olefin thermoplastic resin containing an epoxy group.

12. A molded product for automobiles, domestic electric appliances, or office appliances which is produced by injection-molding the thermoplastic elastomer composition according to claim 1.

13. An automobile seal produced by injection-molding the thermoplastic elastomer composition according to claim 1.

14. A constant-velocity joint boot produced by injection-molding the thermoplastic elastomer composition according to claim 1.

15. An accelerator pedal produced by injection-molding the thermoplastic composition according to claim 1.
